(19) United States
(12) Patent Application Publication
(10) Pub. No.: US 2009/0158265 A1
(43) Pub. Date: Jun. 18, 2009

(54) IMPLEMENTATION OF ADVANCED ENDPOINT FUNCTIONS WITHIN THIRD PARTY SOFTWARE BY USING A PLUG-IN APPROACH

(76) Inventors: Matthew Fenton Davis, Felton, CA (US); Lei Lian, Santa Clara, CA (US); Vivien Chang, Sunnyvale, CA (US); Sandy M. Wen, San Jose, CA (US); Mikhail Taraboukhine, Santa Clara, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 11/956,210

(22) Filed: Dec. 13, 2007

(51) Int. Cl. G06F 9/445

(52) U.S. Cl. 717/168

(57) ABSTRACT

Embodiments described herein generally relate to a method of updating a software routine with subprograms and subroutines that can be accessed by an end user on an as-needed basis. In one embodiment, a method of providing a control function for a semiconductor process to a pre-existing software architecture is described. The method includes providing a plug-in to the pre-existing software architecture, providing an upgrade library file having the control function therein, and uploading the upgrade library file to the pre-existing software architecture at the plug-in to facilitate process control of the semiconductor process.

### BACKGROUND

1. Field

Embodiments of the present invention generally relate to updating a software routine with run-time subprograms and subroutines on an as-needed basis. More specifically, the embodiments described herein relate to providing updated files to a software system for detecting an endpoint in a semiconductor process.

2. Description of the Related Art

In the fabrication of integrated circuits (ICs), various layers of conductive material, insulative material, or semiconducting material are deposited on and removed from a substrate, such as a silicon wafer. Two of the removal techniques are: 1) wet or chemical etching, wherein a photoresist-patterned substrate is immersed in a chemical solution and 2) dry or plasma etching, wherein a substrate is exposed to a bombardment of ions (e.g., a plasma of nitrogen, chlorine, and boron trichloride). Plasma etching processes and apparatus are generally well-known for etching materials in semiconductor device fabrication. The process may begin with application of a masking material, such as photoresist, to a silicon wafer or other substrate. The masking pattern protects areas of the wafer from the etch process. The wafer may then be placed in a plasma reactor and etched after a plasma is ignited. This process is especially valuable for the definition of small geometries.

The plasma reactor may be a stand alone processing tool, which may include peripheral devices, such as a load lock chamber or transfer device, or the plasma reactor may be part of a larger tool having a plurality of chambers adapted for different processes, which are generally referred to as a cluster tool. These processing tools are typically developed by various manufacturers, for example Applied Materials, Inc. of Santa Clara, Calif., and other manufacturers, and are sold to end users for the purpose of fabricating ICs.

The processing tools are typically equipped with a controller that provides control of processing parameters on the tool, such as transfer functions, fluid delivery, electrical applications, vacuum application, mechanical actuation, and process monitoring and control, among other functions. Generally, the controllers on the processing tools, regardless of the tool manufacturer, include some software developed from a functional specification provided by the processing tool manufacturer and/or the end user. In some cases, the process control software executed on the controller may have been developed by a third party, for example, a software provider other than the processing tool manufacturer or the end user.

Part of the original software may include programs to detect endpoints for various processes performed in the plasma reactor, for example, a metric used to detect when an overlying material has been completely removed. This is generally accomplished by detecting the presence of the underlying material, now exposed, in the plasma, such as by using an optical emissions spectroscopy (OES) technique.

Various algorithms have been developed over the years that include instructions for determining an endpoint based on input from OES, and one or more of these algorithms may be included in the original software, which is based on the functional specification that may be provided to the software provider from the processing tool manufacturer and/or end user.

However, ongoing research and development by a particular tool manufacturer may yield a superior endpoint algorithm or an etch depth algorithm subsequent the development of the original software. Consequently, if the end user desires updating the original software to include the new instructions, a new software package may need to be developed. Additionally, a particular tool manufacturer (the innovating manufacturer) may develop a superior endpoint algorithm that may be applicable on processing tools developed by other manufacturers (e.g. a competitor of the innovating manufacturer), and if the end user desires using the endpoint algorithm from the innovating manufacture, the updating process may include retrofitting the original manufacturers processing tool with a subset of software developed by the innovating manufacturer. Other challenges for the innovating manufacture include protecting newly developed algorithms from other manufacturers and/or the end user, which may deter the innovating manufacturer from distributing the newly developed algorithms.

What is needed is a medium of updating existing or original software with upgraded control programs developed after shipment of the tool and/or development of the original software that is inexpensive, timely, indiscriminant of the identity of the processing tool manufacturer and/or software provider, and allows protection of the upgraded control programs.

### SUMMARY

Embodiments described herein generally relate to providing an existing software architecture or software routine with updated subprograms and subroutines that can be accessed by an end user as the updated subprograms and subroutines become available and/or on an as-needed basis. Some embodiments described herein relate to providing updated library files to an existing software system for detecting an endpoint in a semiconductor process.

In one embodiment, a method of providing a control function for a semiconductor process to a pre-existing software architecture is described. The method comprises providing a plug-in to the pre-existing software architecture, providing an upgrade library file having the control function therein, and uploading the upgrade library file to the pre-existing software architecture at the plug-in to facilitate process control of the semiconductor process.

In another embodiment, a method of providing an upgraded control function for a semiconductor process to a pre-existing software architecture in communication with a plasma chamber is described. The method comprises providing a plug-in to the pre-existing software architecture having a first library file therein, providing a second library file having the upgraded control function therein, and replacing the first library file with the upgrade library at the plug-in to facilitate process control in the plasma chamber.

In another embodiment, a computer-readable medium is described comprising a first set of equations for control of a semiconductor process and configured to replace a second set of equations executed by a semiconductor processing tool processor, wherein the first set of equations are bundled into a dynamic linked library (DLL).

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of one embodiment of an exemplary substrate processing system.

FIG. 2 is a schematic diagram of one embodiment of a control system that may be used on the processing system of FIG. 1.

FIG. 3 is a schematic diagram of another embodiment of a control system that may be used on the processing system of FIG. 1.

FIG. 4 is a schematic symbol of one embodiment of an exemplary least mean squares (LMS) adaptive filter.

FIG. 5 is a block diagram of one embodiment of exemplary full spectrum adaptive filter (FSAF) using the LMS adaptive filter of FIG. 3.

FIG. 6 is a flow diagram of one embodiment of exemplary use of FSAF for endpoint detection during substrate etching.

FIGS. 7-10 are exemplary plots of magnitude versus relative time in seconds for FSAF and neural principle component analysis (NPCA) for different open areas.

To facilitate understanding, identical reference numerals have been used, where possible, to designate identical elements that are common to the figures. It is also contemplated that elements disclosed in one embodiment may be beneficially utilized on other embodiments without specific recitation.

### DETAILED DESCRIPTION

Embodiments described herein generally relate to updating a software routine with subprograms and subroutines that can be accessed by an end user on an as-needed basis. More specifically, the embodiments described herein relate to providing updated files to an existing software system for detecting an endpoint in a semiconductor process. Such precise endpoint detection techniques during etch processing of a substrate may be based on optical emission spectrum (OES) data, even in low open area etching. Endpoint detection performed in this manner offers the benefits of increased signal-to-noise ratio and decreased computation costs and delay when compared to conventional endpoint detection techniques. Although the embodiments described herein are described in relation to an endpoint in an etch process, certain embodiments may be applicable to endpoint detection in other semiconductor processes, such as deposition processes, for example chemical vapor deposition (CVD), plasma enhanced chemical vapor deposition (PECVD), atomic layer deposition (ALD), physical vapor deposition (PVD), among other processes. Additionally, embodiments described herein may be applicable for other semiconductor processes, such as chemical mechanical polishing (CMP), electrochemical mechanical polishing (ECMP), among other processes. Additionally, while the processing systems and tools may be described herein as stand-alone processing tools, embodiments described herein may be adapted for cluster tool applications.

### An Exemplary Substrate Etch System

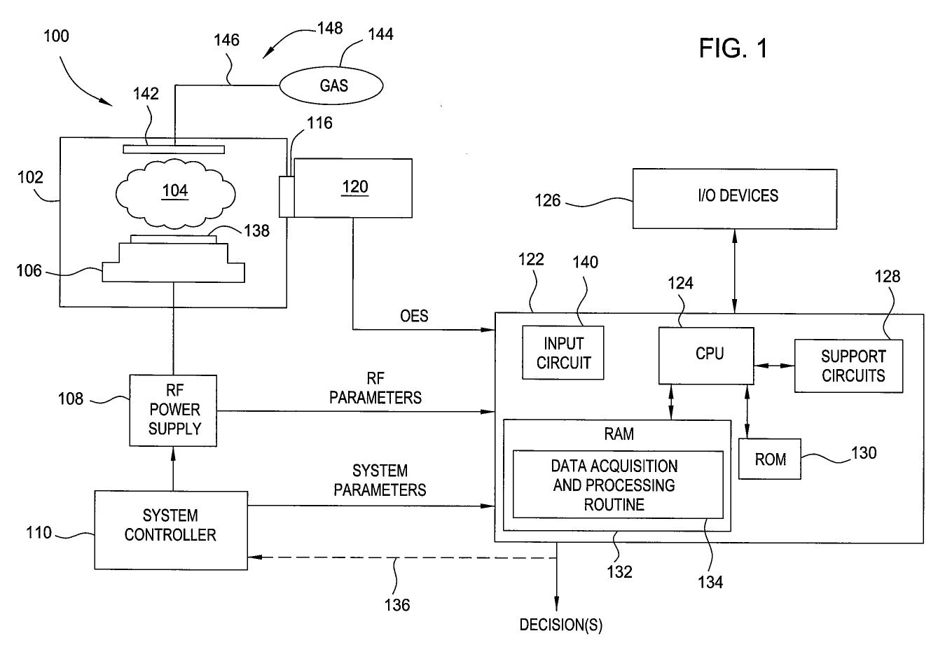

FIG. 1 is a simplified schematic view of a semiconductor substrate processing tool 100 coupled to a signal analyzer 122. The semiconductor substrate processing tool 100 comprises a reaction chamber 102 having a substrate support pedestal or susceptor 106, a radio frequency (RF) power supply 108, a reactive gas supply assembly 148, and a system controller 110. The pedestal 106 may support a substrate or semiconductor wafer 138 in the reaction chamber 102. The pedestal 106 may also form a cathode for the plasma generation system, and in such cases, the cathode may be coupled to the RF power supply 108. For example, in a plasma etching system a plasma may be generated by coupling RF power to a reactive gas. The reactive gas supply assembly 148 may be composed of a gas supply 144 that supplies a reactive gas via conduit 146 and manifold 142 to the reaction chamber 102. To ignite the plasma for some embodiments, RF power may be applied to the cathode. The chamber walls may be grounded, and the electric field between the chamber walls and the cathode may ignite a plasma 104 within the reaction chamber 102.

The system controller 110 may control the plasma-enhanced dry etching of the surface of the substrate 138 including, among other things, the RF power levels. A detailed description of an exemplary etch system can be found in U.S. patent application Ser. No. 11/381,523, filed May 3, 2006, which published as United States Patent Publication No. 2007/0256785 on Nov. 8, 2007, which is incorporated by reference herein.

The signal analyzer 122 may acquire data from a number of sources within the semiconductor substrate processing tool 100. For example, optical emissions of the plasma 104 may be sensed through a transparent window 116 by an optical monitoring system 120. The optical monitoring system 120, shown in FIG. 1 positioned outside the chamber 102 directly in front of the window 116, may convert the optical energy that is coupled through the window 116 into an electrical signal, such as a voltage. The electrical signal may be transmitted as one parameter (e.g., an optical emission spectroscopy (OES) parameter) to the signal analyzer. The optical monitoring system 120 may be any suitable multiple-wavelength optical detector device, such as a Fabry-Perot interferometer or an integrated charge-coupled device (CCD)-based spectrometer with a digital output. One suitable example is the SD1024D Series spectrograph available from Verity Instruments, which responds to wavelengths in the 200-800 nm range.

As described above, the system controller 110 may provide control signals to the RF power supply 108. In addition, the controller 110 may generate system parameter signals which are coupled to an input circuit 140 of the signal analyzer 122. The chamber 102 may also include a number of environmental sensors (not shown) such as temperature sensors, foreline and chamber pressure sensors, reactive gas analyzing sensors and the like. These sensors generally produce analog voltages that may also be coupled to the input circuit 140. The input circuit may synchronize, digitize, and buffer the data, as needed.

The signal analyzer 122 may be a general purpose computer having a central processing unit (CPU) 124, a plurality of input/output (I/O) devices 126, support circuits 128 (e.g., power supplies, clock circuits, bus controllers, cache, and the like), read-only memory (ROM) 130, and random access memory (RAM) 132. The interrelation and operation of these components of a general purpose computer are well known in the art.

The signal analyzer 122 may correlate all or a subset of the parameters that are provided as input to the analyzer. The data acquisition and processing routine 134 may be an executable software program which generally resides in RAM 132 as it is executed by the CPU 124. Decisions made in response to processing the parameters, such as stop etching based on etch endpoint detection, may be provided as an output of the signal analyzer 122. These decisions may be transmitted along path 136 to the system controller 110 for implementation. As such, the system controller 110 may react to these decisions by ending processing should endpoint detection have occurred, or initiating a cleaning function if cleaning of the chamber is deemed required. The parameters and correlated data may also be stored in the RAM 132 for historical review of processing trends. A signal analyzer that may be adapted to benefit from embodiments described herein is the EyeD® full-spectrum, interferometric metrology module, available from Applied Materials, Inc., of Santa Clara, Calif.

Although the signal analyzer 122 is described herein as being a standalone general purpose computer that is programmed to perform the data acquisition and processing functions, these functions may be incorporated into the system controller 110 and executed on the microprocessor of the system controller for some embodiments. For other embodiments, the signal analyzer 122 may be part of an embedded controller or may be combined with the optical monitoring system 120 in a spectrometer, for example, or other embedded application.

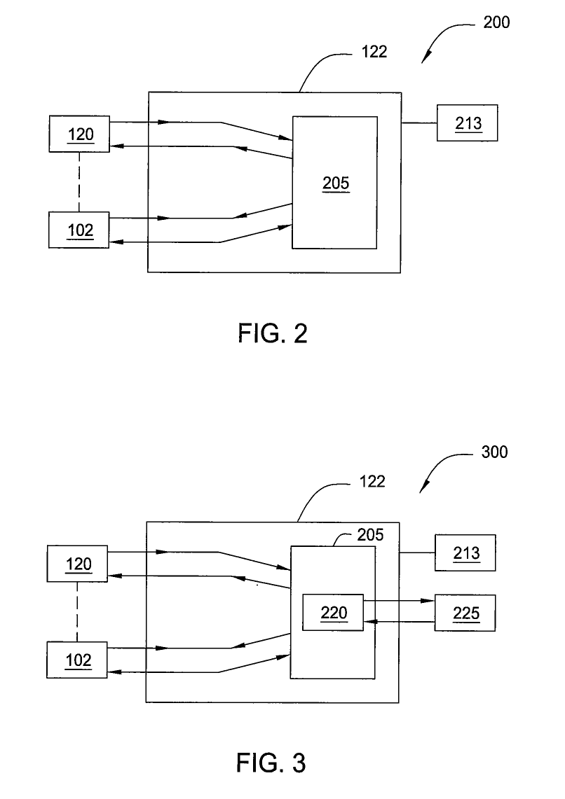

FIG. 2 is a schematic diagram of one embodiment of a control system 200. The control system 200 includes a signal analyzer 122 adapted to transmit and/or receive signals from an optical monitoring system 120, which is coupled to and in communication with a reaction chamber 102. In this embodiment, the signal analyzer 122 includes a pre-existing or original software architecture 205 that may be contained in the RAM 132 of FIG. 1. The original software architecture 205 may be provided by a third party software vendor or provider, for example, a software provider other than the processing tool manufacturer or the end user who operates the tool 100. Communication interfaces (not shown) may also be coupled between the signal analyzer 122, the reaction chamber 102, the optical monitoring system 120, and the original software architecture 205.

In this embodiment, the original software architecture 205 includes a host application, such as source code and standard libraries containing subprograms and subroutines providing process control. The subprograms and subroutines include equation framework, such as saving of an equation configuration file and plotting of the equation output data on a graphical user interface (GUI) 213.

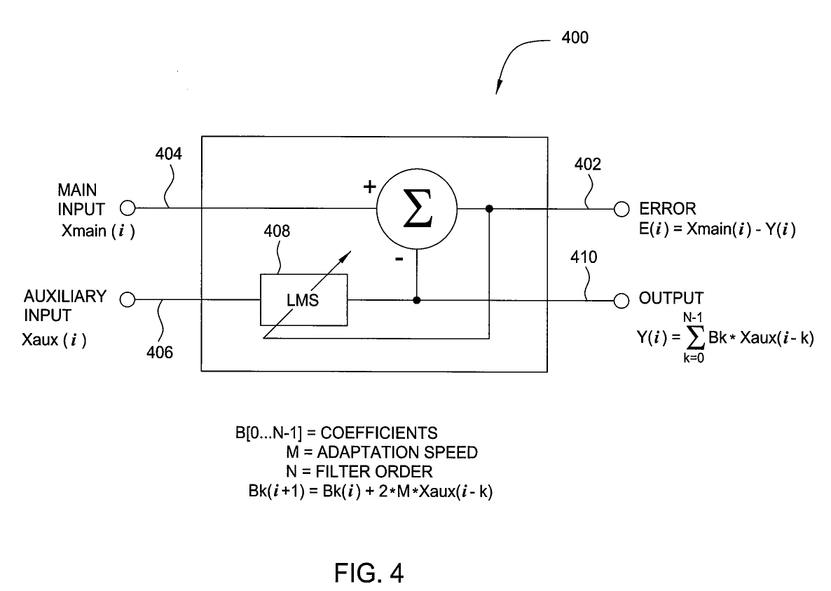

FIG. 3 is a schematic diagram of another embodiment of a control system 300 which is similar to the embodiment shown in FIG. 2 with the exception of a plug-in interface 220 in the original software architecture 205. The plug-in interface 220 is adapted to communicate with an upgrade library file 225, which may be a dynamic linked library (DLL), or any program that allows interaction with the host application in the original software architecture 205.

In one embodiment, the upgrade library file 225 includes upgraded control functions, such as endpoint algorithms to enable process control in the system. The upgraded control functions included in the upgrade library file 225 may have been developed after the original software architecture 205 was implemented, and the end user may want to acquire the updated control algorithms. The plug-in interface 220 may be used with the upgrade library file 225 and other upgrade library files having newly developed endpoint algorithms in future applications. In another embodiment, the upgrade library file 225 includes endpoint algorithms developed by a tool manufacturer or other research and development entity that is different than the original tool manufacturer or not connected with the original tool manufacturer.

As the upgrade library file 225 includes newly developed endpoint algorithms from an innovating tool manufacturer or other research and development entity, there may be concern in distributing the newly developed endpoint algorithms to users as the algorithms may be pirated by competitors and/or modified by competitors and/or end users. The packaging of the newly developed endpoint algorithms into a file library such as a DLL provides the ability to protect the integrity and secrecy of the algorithms, which allows liberated distribution of the algorithms.

The upgrade library file 225 may be easily and timely acquired by the end user. For example, the end user may download the upgrade library file 225 from the innovating tool manufacturer's (or other research and development entity) website and upload file 225 into the original software architecture 205. Other possibilities include selecting upgrade library files 225 from a compact disc or other computer readable medium. Future upgrade library files 225 may be continuously developed by the innovating tool manufacturer and these may be provided to the end user by any suitable medium, such as the World Wide Web, file transfer protocol (FTP), compact disc(s), or other computer readable medium(s), upon request by the end user. If additional programs are required to access the original software architecture and/or upgrade library file 225, these may be provided with the upgrade library file 225. The upgrade file libraries may contain one algorithm for a particular process, contain multiple algorithms for a particular process, or multiple algorithms for different processes, and each of the algorithms may be acquired or purchased separately or in bulk.

The upgrade library file 225 is adapted to integrate seamlessly with the original software architecture 205. The user may upgrade and select algorithms that were previously unavailable in the original software architecture 205 without the need to upgrade the original software architecture 205. The GUI 213 has the same look and feel when used in connection with the plug-in interface 220 and upgrade library file 225. New equations in the upgrade library file 225 are accessed and saved in the same way as the equations in the original software architecture 205. In one embodiment, the equations in the original software architecture 205 are passed to the equation in the upgrade library file 225 by a wrapper class which interfaces with the upgrade library file 225. In one example, existing equation A may be included in the original software architecture 205 and newly developed equation B is provided through the upgrade library file 225. The wrapper class allows equation A to use results of equation B, or vice versa.

The new equation from the upgrade library file 225 may be displayed on the GUI 213 in the same framework as used in the original software architecture 205. Process parameters such as run-time data can also be entered into the equation(s) of the upgrade library file 225 so that inputs may be set by the user. The new equation configuration may be saved as in the original software architecture 205 and the output data may be formatted on the GUI 213 in the original software architecture 205 format.

The endpoint algorithms contained in the upgrade library file 225 are configured to use optical metrology to provide information that enables process adjustment to compensate for incoming pattern inconsistencies (such as critical dimensions (CDs), film thickness, and the like), provide process state monitoring (such as plasma monitoring, temperature monitoring, and the like), and/or end point detection, among others. Some examples include algorithms used in a neural network for etch depth monitoring and control, such as peak finding algorithms, data and/or noise reduction algorithms, among other algorithms or combinations of algorithms.

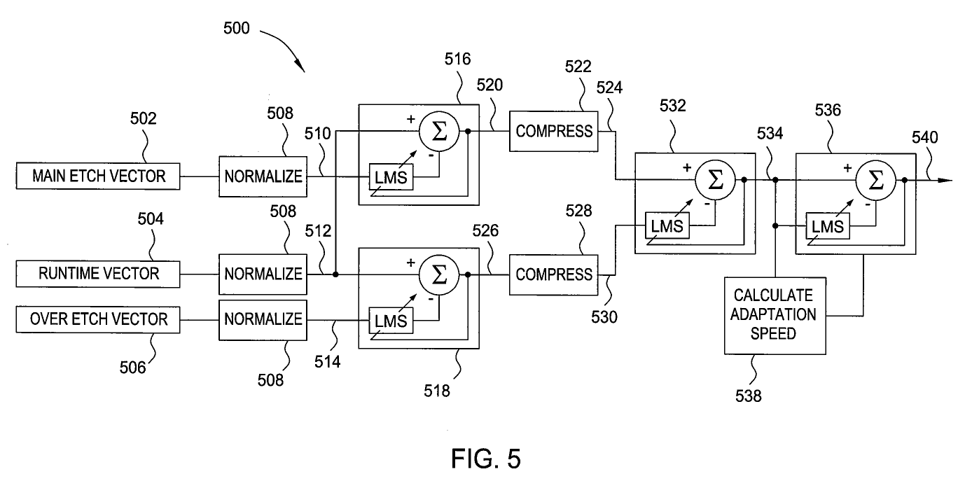

In one embodiment, the upgrade library file 225 includes a digital adaptive filter, which generally refers to a filter which self-adjusts its transfer function according to an optimizing algorithm. FIG. 4 is a schematic symbol of one type of adaptive filter, which uses a least mean squares (LMS) algorithm, otherwise known as the Widrow-Hoff learning algorithm. In the LMS adaptive filter 400, the LMS algorithm may be used in an effort to find the filter coefficients that relate to producing the least mean squares of the error signal 402, or E(i), or the difference between the desired signal (e.g., the signal received on the main input 404, or Xmain(i)) and the filtered actual signal (e.g., the filtered signal received on the auxiliary input 406, or Xaux(i), with the filtered signal being

$$Y ( i ) = {\sum }_{k = 0}^{N - 1} {Bk}^{*} Xaux ( i - k ) )$$

such that E(i)=Xmain(i)−Y(i). The LMS adaptive filter 400 may use the method of steepest descent to find a coefficient vector (B[0 . . . N−1], where N is the filter order) which minimizes the cost function, where the variable filter 408 may be implemented in a finite impulse response (FIR) form (e.g., Bk(i+1)=Bk(i)+2*M*Xaux(i−k), where M is adaptation speed). For some LMS adaptive filters, the estimated signal 410 (i.e., the output of the variable filter 408, or Y(i)) may also be a signal of interest as shown in FIG. 4.

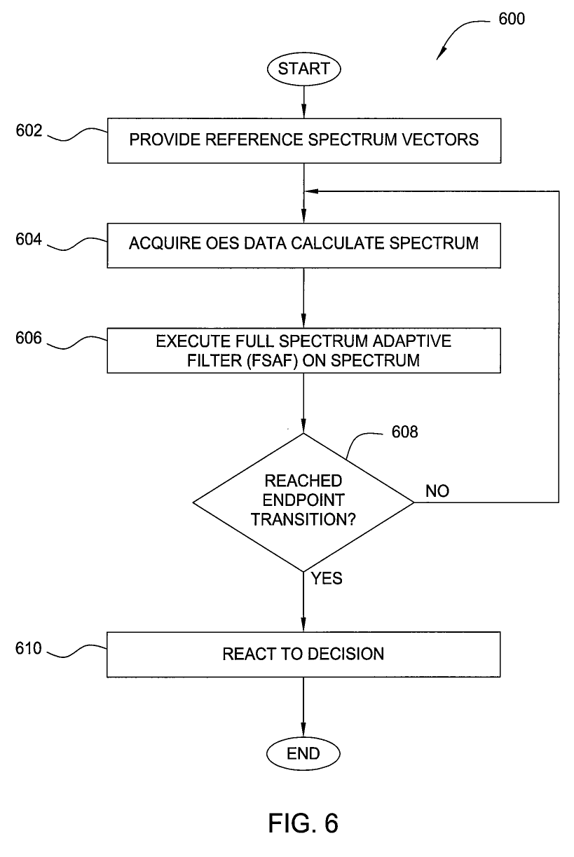

FIG. 5 is a block diagram of a full spectrum adaptive filter 500 employing an adaptive filter as described in FIG. 4. The adaptive filter 500 may have three inputs: a main etch vector 502, a runtime vector 504, and an over etch vector 506. These inputs may be spectral vectors (or spectral arrays potentially converted into vectors) representing the OES from the plasma 104 of FIG. 1, as detected by the optical monitoring system 120 during different phases of the etching process. Since full spectrum adaptive filtering need not detect and focus on a particular wavelength, the input vectors may contain OES data in any order, and different wavelength may overlap each other. However, the structure of the vectors, such as the order of the wavelengths, should match between the three inputs.

The over etch vector 506 may represent a typical OES of the plasma 104 once over etching has occurred, while the main etch vector 502 may represent a typical OES of the plasma 104 after etching has started, but before the etch endpoint has occurred of the same or a similar substrate run of interest. The runtime vector 504 may represent the OES of the plasma 104 in the current etch process as it is occurring. While the over etch and main etch vectors 506, 502 remain static during the endpoint detection techniques described herein, the runtime vector 504 should be a function of process time. The main etch, runtime, and over etch vectors 502, 504, 506 may be representative of optical emission spectrums encompassing the full optical bandwidth or, for some embodiments, the spectrums may be bandlimited to a desired bandwidth.

For some embodiments, other reference OES vectors besides a main etch vector and an over etch vector may be utilized. For example, in cases where it may be desirable to know when a desired amount of material, in some cases less than all of the overlying material, has been removed, a reference vector representing a typical OES of the plasma 104 in this state and before over etching may be used in place of the over etch vector 506. For clarity of explanation, however, the remainder of the description will only consider the main etch and over etch vectors as the reference vectors.

For some embodiments, the resolution of the OESs may be the same for all three vectors 502, 504, 506 such that they have the same vector size. A typical OES resolution may be around 0.5 nm. However, if any one of the vectors represents a spectrum with a different resolution, the size of the vectors may be equated using any suitable mathematical technique known to those skilled in the art, such as interpolation or least squares approximation, in an effort to furnish “missing” elements to the smaller vector(s).

Furthermore for some embodiments, the vectors 502, 504, 506 may be normalized according to Equation 1 below in a normalization routine 508:

$$for ( i = 0 \to size - 1 ) \text{:} out ( i ) = \frac{log ( i n ( i ) )}{{\sum }_{k = 0}^{size - 1} i n ( k )} \qquad ( 1 )$$

where size is the size of the input vector, in(i) is the input spectrum vector at i, and out(i) is the normalized output spectrum vector at i. Normalization may prevent comparator overflow by ensuring that vectors with different magnitudes may still be processed in the full spectrum adaptive filter 500. Although other normalization options besides Equation 1 are available and known to those skilled in the art, normalization according to Equation 1 may also boost the desired signal content with the use of the logarithm function as an added benefit.

As illustrated in FIG. 5, the normalized main etch vector 510 and the normalized runtime vector 512 may be input to the auxiliary input 206 and the main input 204, respectively (FIG. 4), of a first LMS adaptive filter 516. The normalized over etch vector 514 and the normalized runtime vector 512 may be input to the auxiliary input 206 and the main input 204, respectively, of a second LMS adaptive filter 518. The first and second LMS adaptive filters 516, 518 may have matching filter orders and adaptation speeds.

With normalized spectrum vectors as inputs to both filters, the first and second LMS adaptive filters 516, 518 may operate in the “spectrum” domain to compare the vectors and may have significant filter order without introducing unacceptable comparator delay in the time domain. The filter order may be large enough to maintain resolved spectrum lines, which are dictated by the resolution of the input spectrums, but small enough to minimize computation cost. For example, a typical CCD-based optical sensor may collect spectrum data ranging from 200-800 nm with a resolution of 0.5 nm every 100 ms, thereby requiring a sampling speed of at least 12 kS/s. A typical filter order for the first and second LMS adaptive filters 516, 518 may be around 10.

The error output 520 of the first LMS adaptive filter 516 may be compressed according to a compression routine 522 in an effort to form an error value 524 associated with a comparison of the normalized runtime vector 512 and the normalized main etch vector 510. In a similar manner, the error output 526 of the second LMS adaptive filter 518 may be compressed according to a compression routine 528 in an effort to form an error value 530 associated with a comparison of the normalized runtime vector 512 and the normalized over etch vector 514. To generate the error values 524, 530, the compression routines 522, 528 may accumulate the absolute values of the error outputs 520, 526 according to Equation 2 below:

$$for ( i = 0 \to size - 1 ) \text{:} out = {\sum }_{i = 0}^{size - 1} \vert i n ( i ) \vert \qquad ( 2 )$$

where size is the size of one of the error output spectrum vectors 520, 526, in(i) is the error output spectrum vector at i, and out is one of the error values 524, 530, a scalar value instead of a vector. By summing the absolute values of the error output spectrum vectors 520, 526, compression according to Equation 2 may boost the desired signal information by enhancing the differences (whether positive or negative) between the compared vectors. Other compression algorithms (e.g., summing the elements of the error output spectrum vector) known to those skilled in the art may be employed.

The scalar error values 524, 530 may be input to the main and auxiliary inputs of a third LMS adaptive filter 532 for comparison. To eliminate comparator output delay, the third LMS adaptive filter 532 may have a minimum filter order of 1. The error output 534 of the third LMS adaptive filter may be input to both the main and auxiliary inputs of a fourth LMS adaptive filter 536. The filter order of the fourth LMS adaptive filter 536 should be equal to 1. While the adaptation speed of the first 516, second 518, and third LMS adaptive filters 532 may be static, the adaptation speed of the fourth LMS adaptive filter 536 may be calculated dynamically in an adaptation speed routine 538 and variable through several iterations according to Equation 3 below:

$$M = \frac{1}{Max \vert i n ( i ) \vert * Max \vert i n ( i ) \vert} \qquad ( 3 )$$

where M is the adaptation speed of the fourth LMS adaptive filter 536 and in(i) is the error output 534 of the third LMS adaptive filter 532 input to the fourth LMS adaptive filter 536 at iteration i. Due to the “aggressive” nature of the fourth LMS adaptive filter's dynamic adaptive speed, the error output 540 of the fourth LMS adaptive filter 536 may exhibit a sharp transition when reference vectors are reached, thereby offering a suitable comparator output trace for etch endpoint detection, as described in further detail below.

Although not shown in FIG. 5, multiple LMS adaptive filters similar to the fourth LMS adaptive filter 536 may be cascaded in an effort to boost comparator output if desired. The main and auxiliary inputs to each of these cascaded LMS adaptive filters may be the output from the previous filter, and the output of the final cascaded LMS adaptive filter may be used as the comparator output trace for etch endpoint detection.

### An Exemplary Method of Endpoint Detection

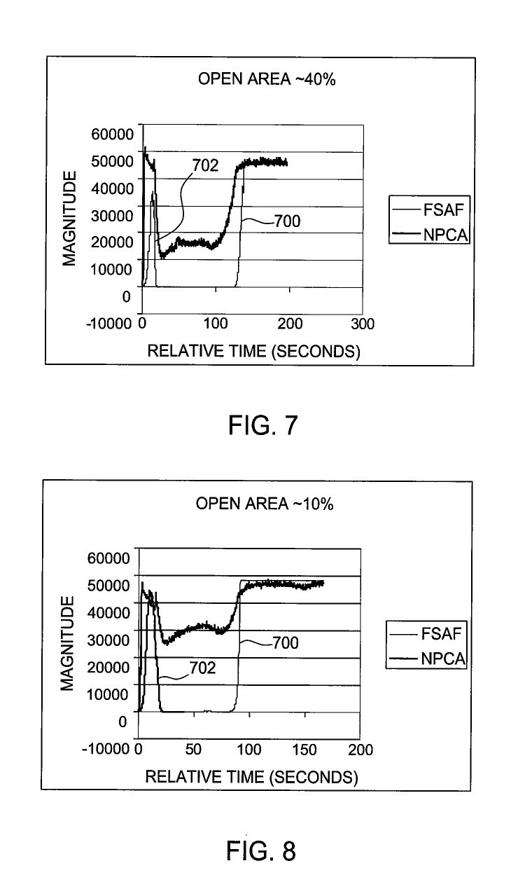

Referring now to FIG. 6, a flow diagram 600 of using full spectrum adaptive filtering (FSAF) contained in the upgrade library file 225 for endpoint detection during substrate etching is depicted. In box 602, the reference OES vectors, such as the main etch vector 502 and the over etch vector 506, may be provided. These reference vectors may have been generated previously from the current substrate processing run or another substrate processing run similar to the current run.

For low open area substrate processing, reference OES vectors from similar substrate processing with larger open area may be collected and provided. Reference vectors from substrates with larger open area may have better signal-to-noise ratio (SNR) than those with low open area, which may be critical for reliable endpoint detection. As an alternative, if large open area data is not available, several reference vectors from low open area substrate processing runs may be averaged to obtain averaged reference vectors, most likely with increased SNR when compared to a single reference vector.

In box 604, runtime OES data may be acquired by detecting optical emissions from the plasma 104 with, for example, the optical monitoring system 120 or the optical sensing portion of a spectrometer or interferometer and calculating the corresponding spectrum. This runtime OES spectrum may encompass the full optical bandwidth (or wavelengths) or may be band limited to a bandwidth of interest.

In any case, a spectrum adaptive filter (e.g., the full spectrum adaptive filter 500 of FIG. 5) may be executed on the reference vectors and the runtime OES vector in box 606 as described above. The FSAF may be performed by the signal analyzer 122, whether the signal analyzer is part of a computer or embedded application. The error output 540 of the fourth LMS adaptive filter 536 may be output, stored, and/or plotted in an effort to determine when an etch endpoint transition has occurred. An endpoint transition may be determined by any suitable means, such as graphically, by crossing a threshold level, or taking the derivative of the output trace to scan for transitions.

If an endpoint transition has not yet occurred, substrate processing may continue in the reaction chamber 102, another runtime OES may be acquired in box 604, and the new runtime OES may be compared in another execution of the full spectrum adaptive filter 500 in box 606 until an endpoint transition has occurred or the loop times out, for example. Once an endpoint transition has been reached, the substrate etching system may automatically react to the decision in box 610 by stopping the etch process immediately or delaying for a predetermined amount of time before stopping the etch process in an effort to ensure complete etching of the substrate 138 in the desired areas. An operator may also manually react to the detection of an endpoint transition in box 608 and stop etching of the substrate 138 immediately or after a predetermined amount of time in box 610.

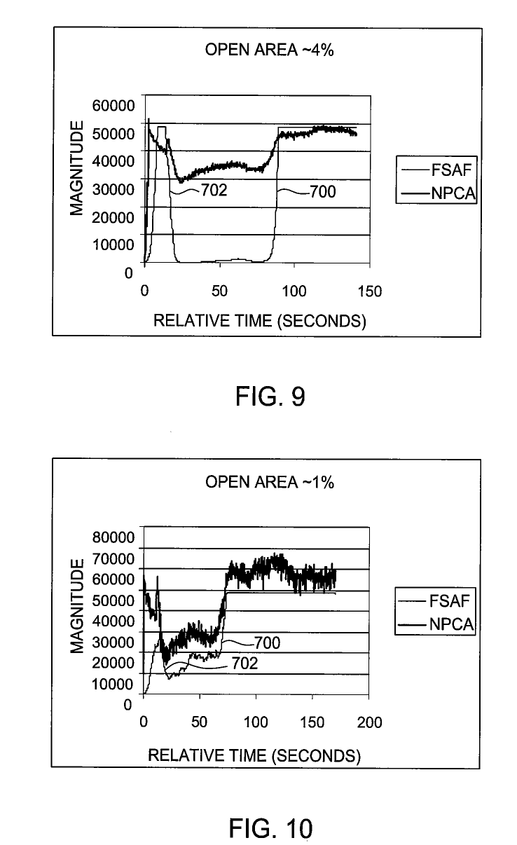

FIGS. 7-10 illustrate plots of the error output 540 of the full spectrum adaptive filter 500 for full spectrum adaptive filtering versus relative time in seconds during substrate etching, where the substrate was poly silicon sandwiched between nitride layers. FIG. 7 depicts endpoint detection using FSAF for a substrate with an open area of approximately 40%. The second rising transition 700 may indicate etch endpoint, and etching of the substrate 138 may be stopped immediately on the rising edge or shortly thereafter. The first falling transition 702 may indicate that the etching of the current substrate has reached the processing point in time where the main etch OES vector 502 was generated such the optical emissions from the plasma 104 are similar. FIGS. 8, 9, and 10 portray endpoint detection using FSAF for a substrate with open areas of approximately 10%, 4%, and 1%, respectively. In generating FIGS. 7-10, the two reference OES vectors were collected at 30 and 150 seconds during 40% open area substrate processing and provided for all of the FSAF endpoint detections shown at 40%, 10%, 4%, and 1% open area.

For comparison purposes, a plot of endpoint detection using neural principle component analysis (NPCA) is also graphed in FIGS. 7-10. Generally speaking, FSAF illustrates that a more definitive, marked endpoint may be detected and a better signal to noise ratio may be achieved when compared to NPCA techniques, even for open areas as low as 1%. Thus, not only is FSAF a significantly faster filter than conventional NPCA techniques, but FSAF is generally more precise at etch endpoint detection, too.

While the foregoing is directed to embodiments of the present invention, other and further embodiments of the invention may be devised without departing from the basic scope thereof, and the scope thereof is determined by the claims that follow.

1. A method of providing a control function for a semiconductor process to a pre-existing software architecture, the method comprising:
providing a plug-in to the pre-existing software architecture;
providing an upgrade library file having the control function therein; and
uploading the upgrade library file to the pre-existing software architecture at the plug-in to facilitate process control of the semiconductor process.

2. The method of claim 1, wherein the control function is an endpoint detection algorithm.

3. The method of claim 1, wherein the control function comprises a program for detecting an endpoint in an etch process using optical emissions spectroscopy (OES).

4. The method of claim 1, wherein the upgrade library file is a dynamic linked library (DLL).

5. The method of claim 1, wherein the upgrade library file is acquired via the World Wide Web.

6. The method of claim 1, wherein the upgrade library file is acquired via file transfer protocol (FTP).

7. The method of claim 1, wherein the upgrade library file is acquired via a compact disc (CD).

8. The method of claim 1, wherein the control function comprises a program used in a neural network.

9. The method of claim 1, wherein the control function comprises a program for a digital adaptive filter.

10. The method of claim 1, wherein the control function comprises a program for a full spectrum adaptive filter (FSAF).

11. A method of providing an upgraded control function for a semiconductor process to a pre-existing software architecture in communication with a plasma chamber, the method comprising:
providing a plug-in to the pre-existing software architecture having a first library file therein;
providing a second library file having the upgraded control function therein; and
replacing the first library file with the upgrade library at the plug-in to facilitate process control in the plasma chamber.

12. The method of claim 11, wherein the upgraded control function is an endpoint detection algorithm.

13. The method of claim 11, wherein the upgraded control function comprises a program for detecting an endpoint in an etch process using optical emissions spectroscopy (OES).

14. The method of claim 11, wherein the upgrade library file is a dynamic linked library (DLL).

15. The method of claim 11, wherein the upgrade library file is acquired via the World Wide Web.

16. The method of claim 11, wherein the upgraded control function comprises a program used in a neural network.

17. The method of claim 11, wherein the upgraded control function comprises a program for a full spectrum adaptive filter (FSAF).

18. A computer-readable medium comprising a first set of equations for control of a semiconductor process and configured to replace a second set of equations executed by a semiconductor processing tool processor, wherein the first set of equations are bundled into a dynamic linked library (DLL).

19. The computer-readable medium of claim 18, wherein the first set of equations, when executed by the semiconductor processing tool processor, performs operations comprising:
(a) providing first and second reference spectrums;
(b) detecting optical emissions during etching of the substrate to generate a runtime optical emission spectrum (OES);
(c) comparing the runtime OES with the first and second reference spectrums using adaptive filtering to generate a comparator output; and
(d) repeating (b) and (c) until the desired etch state is detected based on the comparator output.

20. The computer-readable medium of claim 18, wherein the first reference spectrum is a main etch OES vector and the second reference spectrum is an over etch OES vector.
